(19) United States
(12) Patent Application Publication
(10) Pub. No.: US 2025/0272176 A1
(43) Pub. Date: Aug. 28, 2025

(54) ARTIFICIAL INTELLIGENCE-BASED SYSTEM AND METHOD FOR DETERMINING POTENTIAL ISSUES OCCURRED IN EQUIPMENTS BY ANALYZING DATA USING A ROOT CAUSE ANALYSIS ENGINE

(71) Applicant: Pratexo, Inc., Austin, TX (US)

(72) Inventor: Petter Graff, Austin, TX (US)

(21) Appl. No.: 19/064,833

(22) Filed: Feb. 27, 2025

Related U.S. Application Data
(60) Provisional application No. 63/558,153, filed on Feb. 27, 2024.

(51) Int. Cl. G06F 11/07; G06N 5/022

(52) U.S. Cl. CPC G06F 11/079; G06N 5/022

(57) ABSTRACT

An AI-based system and method for determining potential issues occurred in equipments by analyzing data using a root cause analysis engine, is disclosed. The AI-based method comprises: (a) obtaining the data associated with equipments from databases; (b) identifying potential faults in the equipments based on the data and historical knowledges of the equipments, stored in the databases; (c) identifying potential causes for the potential faults occurred in the equipments; (d) generating indicators based on the potential faults and the potential causes for the potential faults, using an AI model; (e) generating predictions on outcomes and future occurrences in the equipments based on a correlation between the indicators and potential causes, using the AI model; (f) generating responses based on the predictions, using the AI model; and (h) providing the potential faults, potential causes, indicators, predictions, and responses, as an output in form of knowledge graphs, to the users.

### CROSS REFERENCE TO RELATED APPLICATION(S)

This application claims the priority to incorporates by reference the entire disclosure of U.S. provisional patent application No. 63/558,153 filed on Feb. 27, 2024 titled “ARTIFICIAL INTELLIGENCE-BASED SYSTEM AND METHOD FOR PROVIDING ROOT CAUSE ANALYSIS PLATFORM TO ANALYZE STREAMING DATA”.

### TECHNICAL FIELD

Embodiments of the present disclosure relate to root cause analysis systems and more particularly relate to an artificial intelligence-based system and method for determining one or more potential issues occurred in one or more equipments by analyzing data using a root cause analysis engine.

### BACKGROUND

In recent years, the field of root cause analysis within the domain of complex equipment and machines generating streams of internet-of-things data has witnessed substantial advancements with the increasing integration of artificial intelligence (AI) technologies. Traditional approaches to root cause analysis have often grappled with several inherent limitations, thereby prompting the exploration of innovative solutions to address some drawbacks. One prominent limitation of existing technologies is the complex and intricate nature of tools and methodologies employed for root cause analysis. Many of these tools demand a high level of technical proficiency, creating a significant barrier for domain experts who lack programming skills. Consequently, the democratization of root cause analysis, particularly for those without an extensive technical background, remains a challenging endeavor.

The contemporary landscape is characterized by an increasing reliance on streaming Internet-of-things data, necessitating real-time root cause analysis capabilities. Existing technologies, however, often struggle to provide efficient and timely insights in dynamic data environments. The delay in identifying and addressing root causes within streaming data can lead to operational inefficiencies and increased downtime.

Another notable drawback in traditional approaches is the limited adaptability to diverse domains and industries. Root cause analysis tools are often tailored to specific use cases and equipment types, rendering them less versatile for application across a wide range of scenarios. This lack of adaptability impedes the seamless integration of expert knowledge from various domains into the root cause analysis process. The intricacies associated with defining rules and creating algorithms for root cause analysis pose a considerable challenge. Existing systems require a substantial learning curve, demanding extensive training for the domain experts to effectively contribute their valuable insights. This complexity often results in a time-consuming and resource-intensive process.

While generative AI holds great promise in streamlining complex processes, its integration into the root cause analysis systems is limited. The prior art technologies often underutilize the potential of generative AI in automatically generating rules, algorithms, and knowledge graphs, which could significantly enhance the efficiency and effectiveness of the root cause analysis process.

There are various technical problems with a root cause analysis system in the prior art. One of the primary challenges lies in the complexity and inaccessibility of existing tools, which demand technical proficiency. This complexity poses a significant barrier for the domain experts, hindering their effective participation in the root cause analysis process. Additionally, conventional systems often exhibit inefficiencies in providing real-time insights within dynamic data environments, leading to operational delays. Limited adaptability to diverse domains further restrains the versatility of current technologies, making them less conducive to widespread application. The intricate process of defining the rules and creating algorithms in existing systems requires extensive training, contributing to the resource-intensive and time-consuming approach.

Therefore, there is a need for a system to address the aforementioned issues by providing a comprehensive root cause analysis platform, empowering real-time examination of the streaming data for the precise identification and resolution of the potential issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence-based method for determining one or more potential issues occurred in one or more equipments by analyzing data using a root cause analysis engine, is disclosed. The AI-based method comprises obtaining, one or more hardware processors, the data associated with the one or more equipments from one or more databases. In an embodiment, the one or more databases are configured to store the data associated with the one or more equipments, being provided by the one or more users through one or more interfaces associated with one or more communication devices of the one or more users.

The AI-based method further comprises identifying, by the one or more hardware processors, one or more potential faults in the one or more equipments based on at least one of: the data associated with the one or more equipments and one or more historical knowledges of the one or more equipments, stored in the one or more databases. The AI-based method further comprises identifying, by the one or more hardware processors, one or more potential causes for the one or more potential faults occurred in the one or more equipments upon analyzing the one or more potential faults.

The AI-based method further comprises generating, by the one or more hardware processors, one or more indicators based on at least one of: the one or more potential faults and the one or more potential causes for the one or more potential faults, using an artificial intelligence (AI) model. The AI-based method further comprises generating, by the one or more hardware processors, one or more predictions on one or more outcomes and future occurrences in the one or more equipments based on a correlation between the one or more indicators and the one or more potential causes, using the AI model.

The AI-based method further comprises generating, by the one or more hardware processors, one or more responses based on the one or more predictions, using the AI model. In an embodiment, the one or more responses comprise at least one of: one or more control signals and one or more insights, provided to mitigate one or more risks in the one or more equipments, and one or more recommended actions for the one or more users to make one or more informed decisions and timely actions, to mitigate the one or more risks.

The AI-based method further comprises providing, by the one or more hardware processors, at least one of: the one or more potential faults, the one or more potential causes, the one or more indicators, the one or more predictions, and the one or more responses, as an output in a form of one or more knowledge graphs, to the one or more users through the one or more interfaces associated with the one or more communication devices of the one or more users.

In an embodiment, generating the one or more indicators based on at least one of: the one or more potential faults and the one or more potential causes for the one or more potential faults, using the artificial intelligence (AI) model, comprises: (a) obtaining, by the one or more hardware processors, information associated with at least one of: the one or more potential faults and the one or more potential causes; (b) analyzing, by the one or more hardware processors, one or more sensors to generate one or more sensor signals based on at least one of: the one or more potential faults and the one or more potential causes, wherein the one or more sensor signals are interpreted by the one or more indicators; (c) generating, by the one or more hardware processors, one or more values for the one or more indicators by combining the one or more sensor signals; and (d) classifying, by the one or more hardware processors, the one or more indicators for accurately diagnosing and proactively maintaining the one or more equipments, based on the one or more values generated for the one or more indicators.

In another embodiment, generating the one or more predictions, using the AI model, comprises: (a) obtaining, by the one or more hardware processors, the information associated with the one or more indicators; (b) multiplying, by the one or more hardware processors, the one or more indicators by corresponding one or more weights to provide a value to the one or more predictions; (c) determining, by the one or more hardware processors, whether the one or more indicators and the corresponding one or more weights, exceed a pre-determined threshold value; and (d) generating, by the one or more hardware processors, the one or more predictions upon determining that the one or more indicators and the corresponding one or more weights, exceed a pre-determined threshold value.

In yet another embodiment, generating the one or more responses based on the one or more predictions, using the AI model, comprises: (a) obtaining, by the one or more hardware processors, the one or more sensor signals interpreted as the one or more indicators, from the one or more sensors; (b) obtaining, by the one or more hardware processors, one or more expert knowledges comprising pre-defined data associated with at least one of: one or more pre-defined drool rules, one or more pre-defined indicator algorithms, and one or more pre-defined knowledge graphs, from one or more generative AI models based on one or more inputs associated with the one or more expert knowledges, received from one or more expert knowledge systems of one or more domain experts; and (c) executing, by the one or more hardware processors, the one or more expert knowledges comprising the pre-defined data associated with at least one of: the one or more pre-defined drool rules, the one or more pre-defined indicator algorithms, and the one or more pre-defined knowledge graphs, within an AI-based system to generate the one or more predictions and the one or more responses with respect to the predictions in the data associated with the one or more equipments.

In yet another embodiment, the AI-based method further comprises: (a) dynamically receiving, by the one or more hardware processors, the pre-defined data associated with the one or more pre-defined drool rules, from a drool inference engine of the one or more expert knowledge systems; (b) correlating, by the one or more hardware processors, the one or more sensor signals interpreted as the one or more indicators, with the pre-defined data associated with the one or more pre-defined drool rules; and (c) generating, by the one or more hardware processors, the one or more predictions and the one or more responses with respect to the predictions in the data associated with the one or more equipments, based on the correlation of the one or more sensor signals interpreted as the one or more indicators, with the pre-defined data associated with the one or more pre-defined drool rules.

In yet another embodiment, the AI-based method further comprises updating, by the one or more hardware processors, the pre-defined data associated with the one or more pre-defined drool rules, using the drool inference engine, based on one or more changes in at least one of: one or more characteristics of the data associated with the one or more equipments, to one or more analysis requirements, to optimize an adaptability of the AI-based system over time.

In yet another embodiment, the AI-based method further comprises: (a) obtaining, by the one or more hardware processors, data associated with the one or more equipments; (b) correlating, by the one or more hardware processors, the obtained data associated with the one or more equipments, with at least one of: the one or more pre-defined knowledge graphs, one or more documents, and one or more external sources, using a retrieval augmented generation engine; (c) retrieving, by the one or more hardware processors, relevant information from the data associated with the one or more equipments, using the retrieval augmented generation engine; and (d) applying, by the one or more hardware processors, the retrieved relevant information to the retrieval augmented generation engine, to generate the one or more knowledge graphs.

In one aspect, an artificial-intelligence based (AI-based) system for determining one or more potential issues occurred in one or more equipments by analyzing data using a root cause analysis engine, is disclosed. The AI-based system comprises one or more hardware processors, and a memory. The memory is coupled to the one or more hardware processors. The memory comprises a plurality of subsystems in form of programmable instructions executable by the one or more hardware processors.

The plurality of subsystems comprises a data obtaining subsystem configured to obtain the data associated with the one or more equipments from one or more databases. The one or more databases are configured to store the data associated with the one or more equipments, being provided by the one or more users through one or more interfaces associated with one or more communication devices of the one or more users. The plurality of subsystems further comprises a faults identifying subsystem configured to identify one or more potential faults in the one or more equipments based on at least one of: the data associated with the one or more equipments and one or more historical knowledges of the one or more equipments, stored in the one or more databases.

The plurality of subsystems further comprises a causes identifying subsystem configured to identify one or more potential causes for the one or more potential faults occurred in the one or more equipments upon analyzing the one or more potential faults. The plurality of subsystems further comprises an indicator generating subsystem configured to generate one or more indicators based on at least one of: the one or more potential faults and the one or more potential causes for the one or more potential faults, using an artificial intelligence (AI) model.

The plurality of subsystems further comprises a prediction generation subsystem configured to generate one or more predictions on one or more outcomes and future occurrences in the one or more equipments based on a correlation between the one or more indicators and the one or more potential causes, using the AI model. The plurality of subsystems further comprises a response generating subsystem configured to generate one or more responses based on the one or more predictions, using the AI model. The one or more responses comprise at least one of: one or more control signals and one or more insights, provided to mitigate one or more risks in the one or more equipments, and one or more recommended actions for the one or more users to make one or more informed decisions and timely actions, to mitigate the one or more risks.

The plurality of subsystems further comprises an output subsystem configured to provide at least one of: the one or more potential faults, the one or more potential causes, the one or more indicators, the one or more predictions, and the one or more responses, as an output in a form of one or more knowledge graphs, to the one or more users through the one or more interfaces associated with the one or more communication devices of the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture of an AI-based system for determining one or more potential issues occurred in one or more equipments by analyzing data (streaming data) using a root cause analysis engine, in accordance with an embodiment of the present disclosure;

FIG. 2 illustrates a detailed view of the AI-based system for determining the one or more potential issues occurred in the one or more equipments by analyzing the data using the root cause analysis engine, such as those shown in FIG. 1, in accordance with an embodiment of the present disclosure;

FIG. 3A illustrates an exemplary visual representation depicting an interaction of one or more sensors and a response generating subsystem within the AI-based system, in accordance with an embodiment of the present disclosure;

FIG. 3B illustrates an exemplary visual representation depicting the interaction of one or more users with the AI-based system, in accordance with an embodiment of the present disclosure;

FIG. 3C illustrates an exemplary detailed architecture of the AI-based system, in accordance with an embodiment of the present disclosure;

FIG. 3D illustrates an exemplary visual representation depicting learning of one or more domain experts in the one or more expert knowledge systems, in accordance with an embodiment of the present disclosure.

FIG. 3E illustrates an exemplary visual representation depicting generation of expert knowledges including algorithms, rules, and graph packages, using one or more generative AI models, in accordance with an embodiment of the present disclosure;

FIG. 3F illustrates an exemplary visual representation depicting utilization of an expert knowledge package with the AI-based system for determining the one or more potential issues, in accordance with an embodiment of the present disclosure;

FIG. 3G illustrates an exemplary visual representation depicting the interaction of a plurality of subsystems within the AI-based system, in accordance with an embodiment of the present disclosure;

FIG. 3H illustrates an exemplary visual representation depicting generation of one or more knowledge graphs generated on one or more user interfaces, in accordance with an embodiment of the present disclosure; and

FIG. 4 illustrates a flow chart illustrating an AI-based method for determining the one or more potential issues occurred in the one or more equipments by analyzing the data using the root cause analysis engine, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

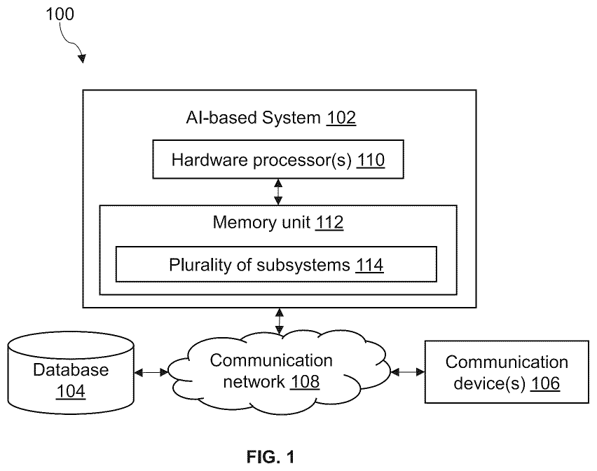

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 of an AI-based system 102 for determining one or more potential issues occurred in one or more equipments by analyzing data (streaming data) using a root cause analysis engine, in accordance with an embodiment of the present disclosure.

According to an exemplary embodiment of the present disclosure, FIG. 1 depicts the network architecture 100 may include the AI-based system 102, one or more databases 104, and one or more communication devices 106. The AI-based system 102 may be communicatively coupled to the one or more databases 104, and the one or more communication devices 106 via a communication network 108. The communication network 108 may be a wired communication network and/or a wireless communication network. The one or more databases 104 may include, but not limited to, storing, and managing data related to the streaming data. The streaming data may include, but not limited to, one or more potential faults, one or more potential causes, one or more indicators, information of one or more sensors, one or more predictions, one or more responses, and the like.

The present invention with the AI-based system 102 is configured to determine the one or more potential issues occurred in the one or more equipments by analyzing the streaming data using the root cause analysis engine. The AI-based system 102 is initially configured to obtain the data associated with the one or more equipments from the one or more databases 104. In an embodiment, the one or more databases 104 are configured to store the data associated with the one or more equipments, being provided by the one or more users through one or more interfaces associated with the one or more communication devices 106 of the one or more users. In an embodiment, the data may be encrypted and decrypted by the AI-based system 102, so that one or more third party users cannot be authenticated to manipulate the data.

The AI-based system 102 is further configured to identify one or more potential faults in the one or more equipments based on at least one of: the data associated with the one or more equipments and one or more historical knowledges of the one or more equipments, stored in the one or more databases 104. The AI-based system 102 is further configured to identify one or more potential causes for the one or more potential faults occurred in the one or more equipments upon analyzing the one or more potential faults. The AI-based system 102 is further configured to generate one or more indicators based on at least one of: the one or more potential faults and the one or more potential causes for the one or more potential faults, using an artificial intelligence (AI) model.

The AI-based system 102 is further configured to generate one or more predictions on one or more outcomes and future occurrences in the one or more equipments based on a correlation between the one or more indicators and the one or more potential causes, using the AI model. The AI-based system 102 is further configured to generate one or more responses based on the one or more predictions, using the AI model. In an embodiment, the one or more responses may include at least one of: one or more control signals and one or more insights, provided to mitigate one or more risks in the one or more equipments, and one or more recommended actions for the one or more users to make one or more informed decisions and timely actions, to mitigate the one or more risks.

The AI-based system 102 is further configured to provide at least one of: the one or more potential faults, the one or more potential causes, the one or more indicators, the one or more predictions, and the one or more responses, as an output in a form of one or more knowledge graphs, to the one or more users through the one or more interfaces associated with the one or more communication devices 106 of the one or more users.

The one or more databases 104 may be any kind of database such as, but not limited to, relational databases, non-relational databases, graph databases, document databases, dedicated databases, dynamic databases, monetized databases, scalable databases, cloud databases, distributed databases, any other databases, and a combination thereof. The one or more databases 104 are configured to support the functionality of the AI-based system 102 and enables efficient data retrieval and storage for various aspects associated with the streaming data and knowledge of equipment.

The one or more databases 104 may also include a graph database management system including a Neo4j. The graph database management system is configured to build the one or more knowledge graphs. In the AI-based system 102, the one or more knowledge graphs serve as a valuable resource for understanding a behavior of the one or more equipments and guiding the root cause analysis process.

In an exemplary embodiment, the one or more communication devices 106 may include, but not limited to, a mobile device, a smartphone, a Personal Digital Assistant (PDA), a tablet computer, a phablet computer, a wearable computing device, a laptop, a desktop, and the like.

This integrated network architecture 100 facilitates seamless communication and data exchange, enabling the AI-based system 102 to operate cohesively for providing the root cause analysis platform to analyze the streaming data using the one or more artificial intelligence models. The AI-based system 102 capability to provide the root cause analysis of the one or more equipments is underpinned by the effective collaboration among the AI-based system 102, the one or more databases 104, and the one or more communication devices 106 within the communication network 108.

Further, the AI-based system 102 may be implemented by way of a single device or a combination of multiple devices that may be operatively connected or networked together. The AI-based system 102 may be implemented in hardware or a suitable combination of hardware and software. The AI-based system 102 includes one or more hardware processors 110, and a memory unit 112. The memory unit 112 may include a plurality of subsystems 114. The AI-based system 102 may be a hardware device including the one or more hardware processors 110 executing machine-readable program instructions for providing the root cause analysis platform (otherwise called as a root cause analysis engine) to analyze the streaming data using the one or more AI models. Execution of the machine-readable program instructions by the one or more hardware processors 110 may enable the AI-based system 102 to dynamically recommend a course of action sequence for providing a root cause analysis platform to analyze the streaming data.

The course of action sequences may involve various steps or decisions taken for data obtaining, fault identifying, cause identifying, indicator analyzing, prediction generating, and response generating. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory unit 112 operationally coupled with the AI-based system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, any other devices, and combination thereof. A person skilled in the art should not be limiting the components/subsystems shown in FIG. 1.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the AI-based system 102 as is unique to the present disclosure or necessary for an understanding of the present disclosure is depicted and described. The remainder of the construction and operation of the AI-based system 102 may conform to any of the various current implementations and practices that were known in the art.

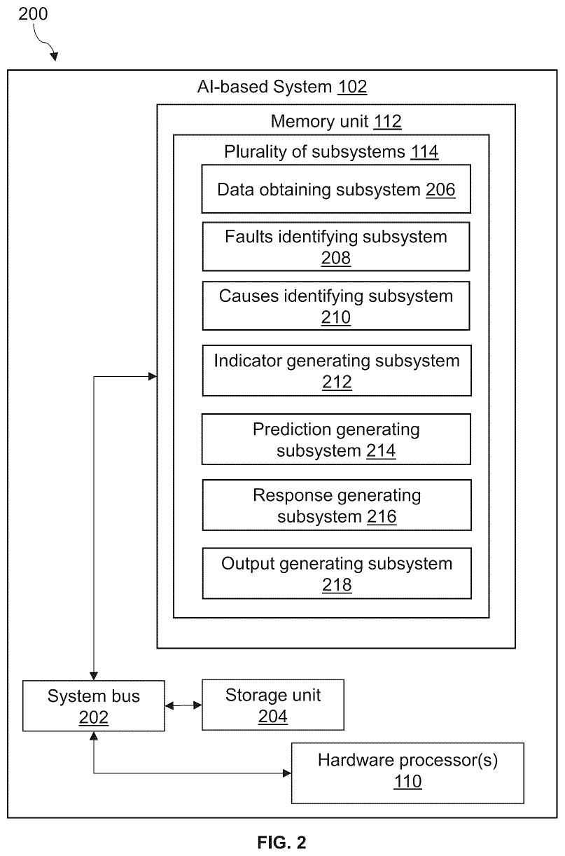

FIG. 2 illustrates a detailed view 200 of the AI-based system 102 for determining the one or more potential issues occurred in the one or more equipments by analyzing the data using the root cause analysis engine, such as those shown in FIG. 1, in accordance with an embodiment of the present disclosure.

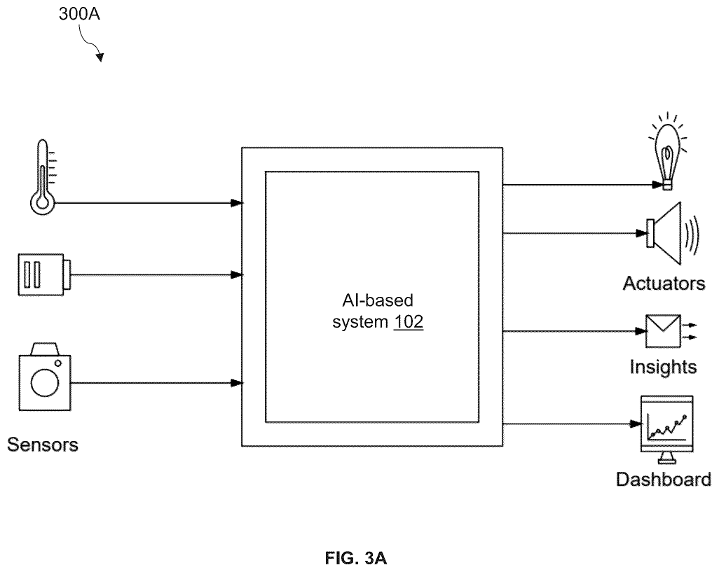

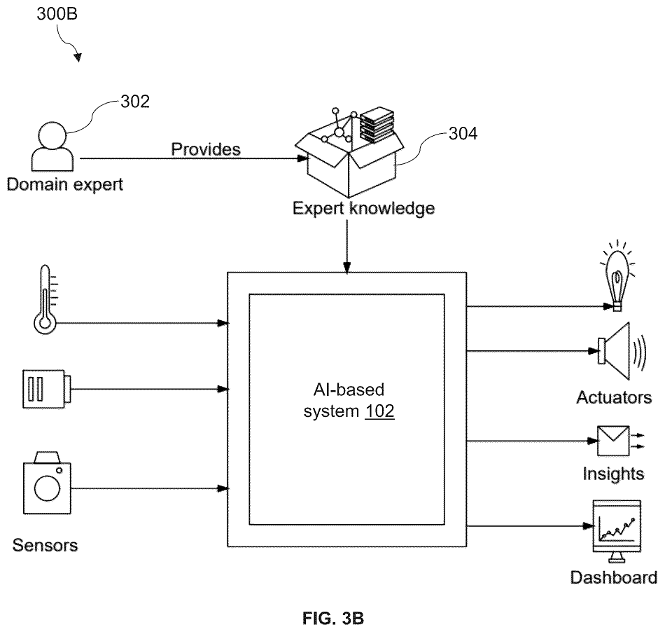

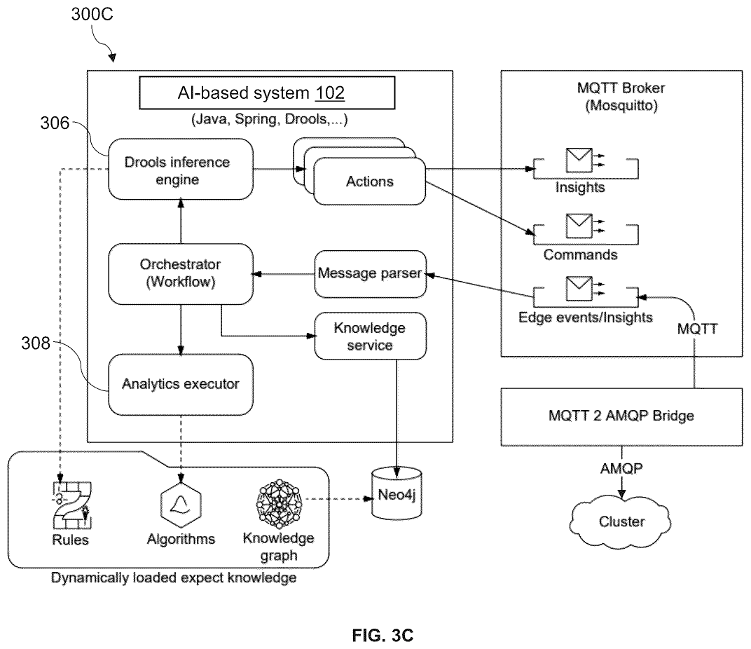

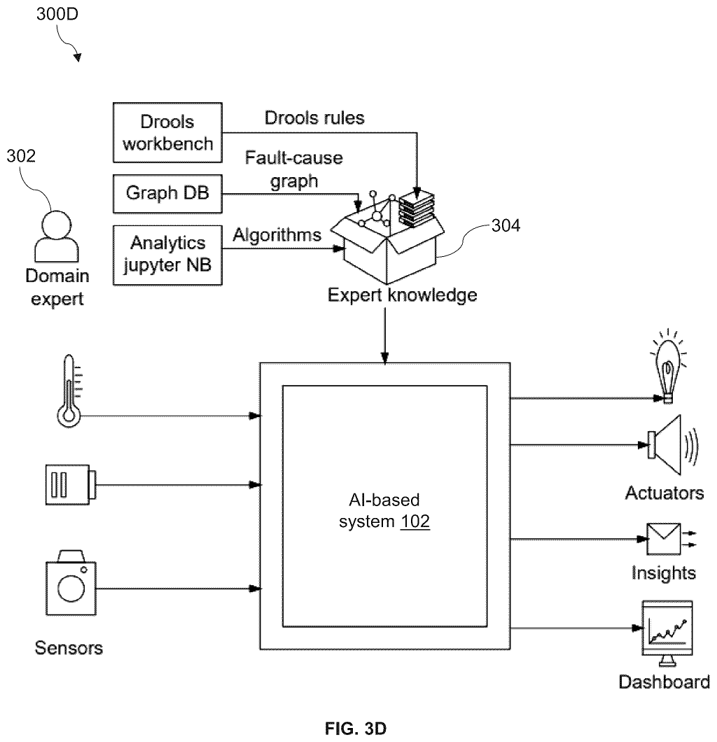

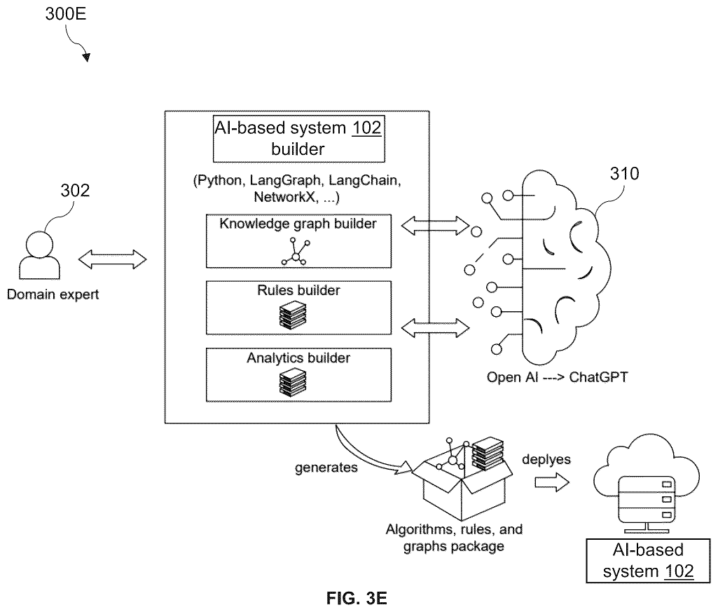

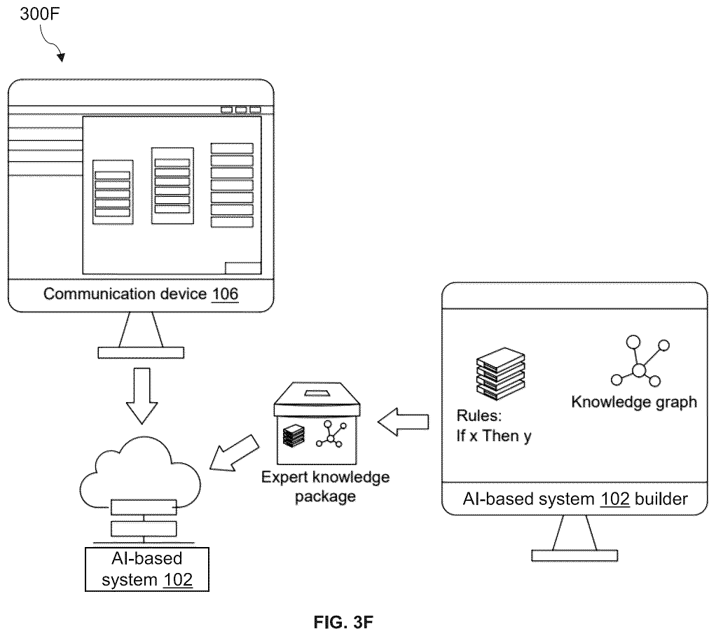

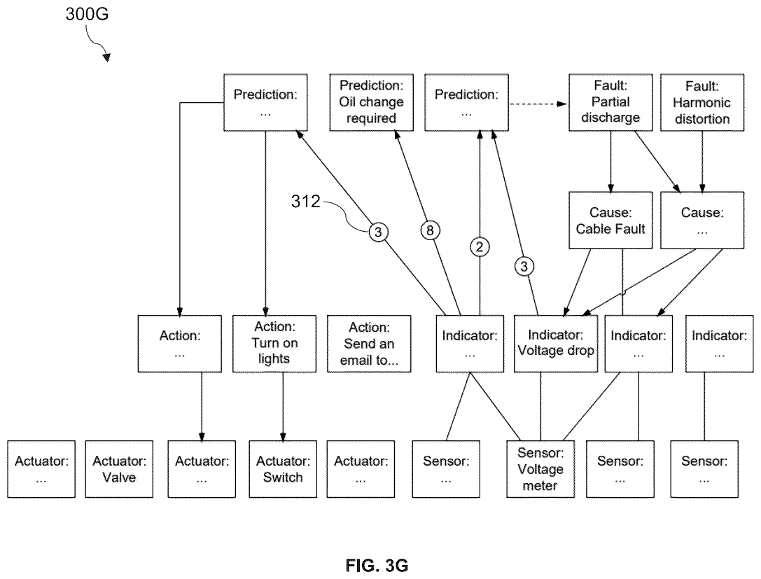

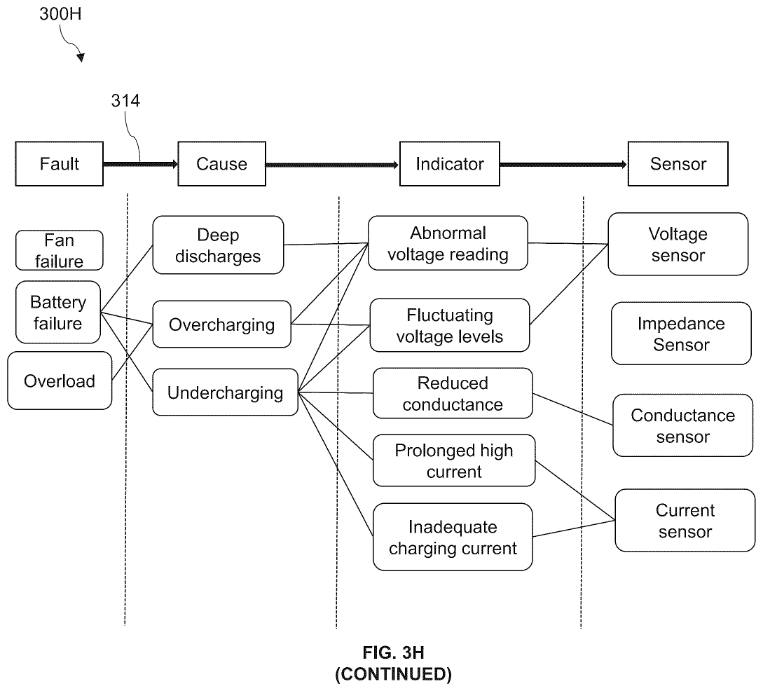

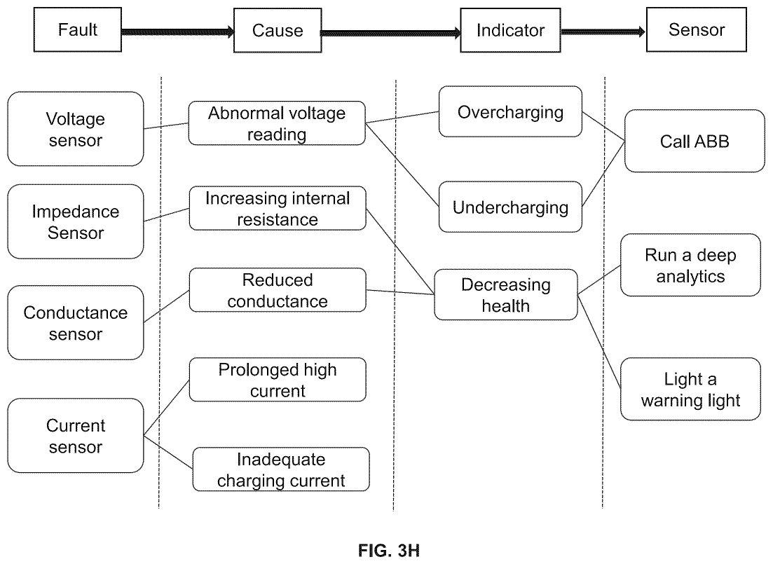

FIG. 3A illustrates an exemplary visual representation 300A depicting an interaction of one or more sensors and a response generating subsystem 216 within the AI-based system 102, in accordance with an embodiment of the present disclosure.

FIG. 3B illustrates an exemplary visual representation 300B depicting the interaction of one or more domain experts 302 with the AI-based system 102, in accordance with an embodiment of the present disclosure.

FIG. 3C illustrates an exemplary detailed architecture 300C of the AI-based system 102, in accordance with an embodiment of the present disclosure.

FIG. 3D illustrates an exemplary visual representation 300D depicting learning of one or more domain experts 302 in the one or more expert knowledge systems, in accordance with an embodiment of the present disclosure.

FIG. 3E illustrates an exemplary visual representation 300E depicting generation of expert knowledges 304 including algorithms, rules, and graph packages, using one or more generative AI models 310, in accordance with an embodiment of the present disclosure.

FIG. 3F illustrates an exemplary visual representation 300F depicting utilization of an expert knowledge package with the AI-based system 102 for determining the one or more potential issues, in accordance with an embodiment of the present disclosure.

FIG. 3G illustrates an exemplary visual representation 300G depicting the interaction of the plurality of subsystems 114 within the AI-based system 102, in accordance with an embodiment of the present disclosure.

FIG. 3H illustrates an exemplary visual representation 300H depicting generation of one or more knowledge graphs 314 generated on one or more user interfaces, in accordance with an embodiment of the present disclosure.

The AI-based system 102 comprises the one or more hardware processors 110, the memory unit 112, and a storage unit 204. The one or more hardware processors 110, the memory unit 112, and the storage unit 204 are communicatively coupled through a system bus 202 or any similar mechanism. The memory unit 112 is operatively coupled to the one or more hardware processors 110. The memory unit 112 comprises the plurality of subsystems 114 in the form of programmable instructions executable by the one or more hardware processors 110.

In an exemplary embodiment, the plurality of subsystems 114 comprises a data obtaining subsystem 206, a faults identifying subsystem 208, a causes identifying subsystem 210, an indicator generating subsystem 212, a prediction generating subsystem 214, the response generating subsystem 216, and an output subsystem 218.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory unit 112 may be a non-transitory volatile memory and a non-volatile memory. The memory unit 112 may be coupled to communicate with the one or more hardware processors 110, such as being a computer-readable storage medium. The one or more hardware processors 110 may execute machine-readable instructions and/or source code stored in the memory unit 112. A variety of machine-readable instructions may be stored in and accessed from the memory unit 112. The memory unit 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 112 includes the plurality of subsystems 114 stored in the form of machine-readable instructions on any of the above-mentioned storage media and may be in communication with and executed by the one or more hardware processors 110.

The storage unit 204 may be a cloud storage or the one or more databases 104 such as those shown in FIG. 1. The storage unit 204 may store, but not limited to, recommending a course of action sequences, applications, application links, application name, application description, application meta-data, application identifier, display names of the one or more applications, short textual description, a universal resource locator (URL) of the one or more applications, and a list of parameters corresponding to an application context, generated recommending course of action sequences, one or more clickable elements, completion status of initiated user action through recommended course of action sequences, feedback loops, feedback from the one or more users, query parameters, additional query parameters, deep integration parameters, up-sell/x-sell product links, tracked user click-through rates, any other data, and combinations thereof. The storage unit 204 may be any kind of database such as, but not limited to, relational databases, dedicated databases, dynamic databases, monetized databases, scalable databases, cloud databases, distributed databases, any other databases, and a combination thereof.

The plurality of subsystems 114 includes the data obtaining subsystem 206 that is communicatively connected to the one or more hardware processors 110. The data obtaining subsystem 206 is configured to obtain the data (i.e., equipment data) associated with the one or more equipments from the one or more databases 104. The data obtaining subsystem 206 serves as a foundation for the AI-based system 102, acquiring the equipment data necessary for further analysis. In an embodiment, the one or more databases 104 are configured to store the data associated with the one or more equipments, being provided by the one or more users through one or more interfaces associated with the one or more communication devices 106 of the one or more users.

The one or more user interfaces are configured to allow the one or more users to interact with the AI-based system 102. The one or more interfaces allow the one or more users to provide the equipment data. The equipment data may include, but not limited to, at least one of a: name of the one or more equipments, detailed information of the one or more equipments, a portable document format (PDF) related to the one or more equipments, a uniform resource locator (URL) related to the one or more equipments, and the like. The one or more users may upload the equipment data through form filling, file uploading, and the like provided by the one or more user interfaces. The one or more equipments may include, but not limited to, at least one of a: car, strainpress, pump, and the like. The one or more users may include, but not limited to, equipment owners, domain experts, and the like.

The plurality of subsystems 114 includes the faults identifying subsystem 208 that is communicatively connected to the one or more hardware processors 110. The faults identifying subsystem 208 is configured to identify the one or more potential faults in the one or more equipments based on at least one of: the data associated with the one or more equipments and one or more historical knowledges of the one or more equipments, stored in the one or more databases 104. In an embodiment, a list of the one or more potential faults may be present on the one or more user interfaces.

Additionally, the one or more users are configured with the option to manually enter the one or more potential faults into the one or more user interfaces, allowing for flexibility and customization to accommodate unique scenarios and issues specific to the one or more equipment. Also, the one or more users are configured to remove the one or more potential faults from the list of the one or more potential faults if deemed irrelevant by the one or more users. This approach ensures a comprehensive fault identification and enables the one or more users to contribute their expertise to the fault identification, enhancing an accuracy and a relevance to real-world situations.

The plurality of subsystems 114 includes the causes identifying subsystem 210 that is communicatively connected to the one or more hardware processors 110. The causes identifying subsystem 210 is configured to identify the one or more potential causes occurred in the one or more equipments upon analyzing the one or more potential faults. The causes identifying subsystem 210 is configured to generate a list of the one or more potential causes. The list of the one or more potential causes is depicted on the one or more user interfaces.

The causes identifying subsystem 210 is configured to analyze the one or more potential faults and extrapolate the likely one or more potential causes, facilitating a structured approach to understanding and addressing underlying issues within the AI-based system 102. Also, the one or more users are configured to remove the one or more potential causes and add the one or more potential causes in the list of the one or more potential causes.

The plurality of subsystem 114 further includes the indicator generating subsystem 212 that is communicatively connected to the one or more hardware processors 110. The indicator generating subsystem 212 is configured to generate one or more indicators based on at least one of: the one or more potential faults and the one or more potential causes for the one or more potential faults, using the artificial intelligence (AI) model. For generating the one or more indicators based on at least one of: the one or more potential faults and the one or more potential causes for the one or more potential faults, using the artificial intelligence (AI) model, the indication generating subsystem 212 is initially configured to obtain information associated with at least one of: the one or more potential faults and the one or more potential causes. The indication generating subsystem 212 is further configured to analyze one or more sensors to generate one or more sensor signals based on at least one of: the one or more potential faults and the one or more potential causes. In an embodiment, the one or more sensor signals are interpreted by the one or more indicators.

The indication generating subsystem 212 is further configured to generate one or more values for the one or more indicators by combining the one or more sensor signals. In an embodiment, the one or more values may be fluctuated. The indication generating subsystem 212 is further configured to classify the one or more indicators for accurately diagnosing and proactively maintaining the one or more equipments, based on the one or more values generated for the one or more indicators.

For instance, a zero value refers to no indication, and a hundred value refers to a very strong indication. The one or more indicators are crucial for accurate diagnosis and proactive maintenance of the one or more equipments. The one or more indicators serve as observable signals or patterns that provide evidence and insights into the occurrence of the one or more potential faults. By identifying and monitoring the one or more indicators, the one or more users establish correlations between observed symptoms and the potential underlying issues, enabling the one or more users to preemptively address the one or more potential faults before the equipment escalates into critical failures.

The plurality of subsystems 114 further includes the prediction generating subsystem 214 that is communicatively connected to the one or more hardware processors 110. The prediction generating subsystem 214 is configured to generate the one or more predictions on the one or more outcomes and the future occurrences in the one or more equipments based on the correlation between the one or more indicators and the one or more potential causes, using the AI model.

The prediction generating subsystem 214 is configured to compare the one or more indicators and the one or more potential causes to generate the one or more predictions. For generating the one or more predictions, using the AI model, the prediction generating subsystem 214 is initially configured to obtain the information associated with the one or more indicators. The prediction generating subsystem 214 is further configured to multiply the one or more indicators by corresponding one or more weights 312 to provide a value to the one or more predictions. The prediction generating subsystem 214 is further configured to determine whether the one or more indicators and the corresponding one or more weights 312, exceed a pre-determined threshold value. The prediction generating subsystem 214 is configured to generate the one or more predictions upon determining that the one or more indicators and the corresponding one or more weights 312, exceed a pre-determined threshold value.

In other words, the prediction generating subsystem 214 is configured to analyze the correlation between the one or more observed indicators and the one or more potential causes to forecast one of: potential outcomes and future occurrences. The combination of the one or more indicators provides the one or more predictions. An indicator strength is multiplied by a weight, and that provides a certain value to the one or more predictions. The one or more predictions is configured with a threshold value.

In the event where the product of the indicator strength and its associated weight surpasses the predetermined threshold value, the prediction generating subsystem 214 is configured to generate a prediction. Subsequently, if this prediction is configured with the one or more indicators, the summation of their respective values should be considered.

The plurality of subsystems 114 further includes the response generating subsystem 216 that is communicatively connected to the one or more hardware processors 110. The response generating subsystem 216 is configured to generate the one or more responses based on the one or more predictions, using the AI model (as shown in FIG. 3A). The one or more responses are tailored to address the predicted scenarios effectively, ranging from preventive maintenance tasks to immediate corrective actions. The one or more generated responses provide one or more valuable insights and one or more recommendations to the one or more users, enabling the one or more users to make informed decisions and take timely actions to mitigate risks, optimize equipment performance, and ensure operational continuity.

The one or more responses may include, but not limited to, at least one of: one or more control signals, provide one or more insights, and the like. The one or more control signals are dispatched to one or more actuators, enabling automated adjustments and interventions to rectify the identified issues or optimize performance parameters of the one or more equipments in real-time. The one or more insights of the one or more equipments may be communicated via emails, messages on collaboration platforms like Slack, short message service (SMS) notifications, and the like. The one or more generated responses are utilized to populate dashboards, with comprehensive visualizations and analytics to monitor the health of the equipment, performance trends, and operational metrics.

In an embodiment, for generating generating the one or more responses based on the one or more predictions, using the AI model, the response generating subsystem 216 is initially configured to obtain the one or more sensor signals interpreted as the one or more indicators, from the one or more sensors. The response generating subsystem 216 is further configured to obtain one or more expert knowledges 304 (as shown in FIG. 3B) comprising pre-defined data associated with at least one of: one or more pre-defined drool rules, one or more pre-defined indicator algorithms, and one or more pre-defined knowledge graphs, from one or more generative AI models 310 (as shown in FIG. 3E) based on one or more inputs associated with the one or more expert knowledges 304, received from one or more expert knowledge systems of one or more domain experts 302. In an embodiment, the one or more generative AI models 310 may include at least one of: Generative Pre-Trained Transformer (GPT), Large Language Model Meta AI (LlaMA), and the like.

In an embodiment, the one or more expert knowledges 304 are learned or trained from the AI-based system 102 or a local expert system. As shown in FIG. 3C, the one or more rules are loaded/learned from a drools inference engine 306 of the AI-based system 102 or a local expert system. Further, the one or more algorithms are loaded/learned from an analytics executor 308 of the AI-based system 102 or a local expert system. Further, the one or more knowledge graphs 314 are loaded/learned from the graph database management system including the Neo4j. In an embodiment, the one or more actions in the AI-based system 102 or a local expert system are configured to generate one or more commands, one or more insights, and the like.

In an embodiment, the one or more expert knowledges 304 comprising the one or more pre-defined drool rules, the one or more pre-defined indicator algorithms, and the one or more pre-defined knowledge graphs, are retrieved from a drools workbench, an analytics Jupyter NB, and a graph database, respectively (as shown in FIG. 3D), which are utilized by the AI-based system 102 to generate the one or more responses.

The response generating subsystem 216 is further configured to execute the one or more expert knowledges 304 comprising the pre-defined data associated with at least one of: the one or more pre-defined drool rules, the one or more pre-defined indicator algorithms, and the one or more pre-defined knowledge graphs, within the AI-based system 102 generate the one or more predictions and the one or more responses with respect to the predictions in the data associated with the one or more equipments.

In an embodiment, the one or more expert knowledge packages are retrieved from the AI-based system 102. The pre-defined data associated with at least one of: the one or more pre-defined drool rules, and the one or more pre-defined knowledge graphs, are pre-configured in the AI-based system 102 builder. The pre-defined one or more algorithms stored in the one or more communication devices 106 are combined with the pre-defined drool rules, and the one or more pre-defined knowledge graphs. The combined data associated with the expert knowledge package is being executed by the AI-based system 102 to generate the one or more responses (as shown in FIG. 3F).

FIG. 3G illustrates an exemplary visual representation 300G depicting the interaction of the plurality of subsystems 114 within the AI-based system 102, in accordance with an embodiment of the present disclosure. As shown in FIG. 3G, the one or more potential faults are identified in the one or more equipments based on at least one of: the data associated with the one or more equipments and one or more historical knowledges of the one or more equipments, stored in the one or more databases 104. The one or more potential causes are identified for the one or more potential faults occurred in the one or more equipments upon analyzing the one or more potential faults.

The one or more indicators are generated based on at least one of: the one or more potential faults and the one or more potential causes for the one or more potential faults, using an artificial intelligence (AI) model. The one or more indicators are classified upon analyzing the one or more sensors that are configured to generate the one or more sensor signals based on at least one of: the one or more potential faults and the one or more potential causes.

The one or more predictions are generated upon determining that the one or more indicators and the corresponding one or more weights 312, exceed a pre-determined threshold value. In an embodiment, the one or more predictions are used to identify the one or more faults. The one or more responses are generated based on the one or more predictions, using the AI model. In an embodiment, the one or more responses comprise at least one of: the one or more control signals and the one or more insights, provided to mitigate the one or more risks in the one or more equipments, and the one or more recommended actions for the one or more users to make the one or more informed decisions and the timely actions, to mitigate the one or more risks. The AI-based system 102 is configured to utilize the one or more actuators to rectify the identified issues or optimize the performance parameters of the one or more equipments in real-time.

In an exemplary embodiment, the one or more potential faults, the one or more potential causes, the one or more indicators, the one or more sensors, the one or more predictions, and the one or more responses are displayed on the one or more user interfaces in the form of the one or more knowledge graphs 314. The one or more user interfaces are also configured to provide one or more indicator algorithms based on the one or more input sensors provided by the one or more users. The one or more indicator algorithms assist in detecting anomalies or deviations from expected behavior in the streaming data. By analyzing patterns and trends in the streaming data, the one or more indicator algorithms identify unusual fluctuations or outliers that may indicate the one or more potential issues and the one or more potential causes.

The one or more indicators serve as an early warning by flagging potential problems before they escalate into larger issues. The one or more indicator algorithms alert the one or more users to abnormal conditions that require attention and intervention. By examining correlations between the one or more indicators and the one or more potential causes, the AI-based system 102 uncover underlying factors contributing to observe the anomalies and the patterns. By analyzing historical patterns and trends in the streaming data, the one or more indicator algorithms generate the one or more predictions about the future occurrences, allowing the one or more users to proactively address the potential issues before they occur.

In an exemplary embodiment, the one or more knowledge graphs 314, the one or more indicator algorithms, and the one or more drool rules are generated by employing one or more artificial intelligence models. The one or more artificial intelligence models may include, but not limited to, Large Language Model (LLM), the drools inference engine 306, retrieval augmented generation, and the like.

The drools inference engine 306 is a forward chaining rules system utilized to execute the drool rules within the AI-based system 102, enabling logical decision-making. The drools inference engine 306 allows the AI-based system 102 to implement complex decision-making logic based on the pre-defined drool rules. The pre-defined drool rules are derived from the one or more users and encapsulate the conditions and the actions necessary for identifying the one or more potential causes of the streaming data. The drools inference engine 306 are capable of real-time rule evaluation, making drools suitable for processing the streaming data as it arrives. This enables the AI-based system 102 to perform immediate analysis and the one or more responses to the incoming streaming data, which is crucial for identifying and addressing issues with the one or more equipments.

The drools inference engine 306 is designed to handle large volumes of the rules efficiently, making it scalable for the AI-based system 102 dealing with the diverse equipment data and complex decision criteria. This ensures that the AI-based system 102 effectively manages the variety of streaming data. The drools inference engine 306 provides a flexible framework for defining and modifying the rules without requiring extensive software development. This allows the one or more users to adjust the rules set as needed to accommodate changes in the data characteristics, or analysis requirements, enhancing the adaptability of the AI-based system 102 over time.

In an exemplary embodiment, the retrieval augmented generation engine of the response generating subsystem 216 is configured to process the obtained equipment data to leverage the existing knowledge, documents, and external sources to enhance the generation of the one or more knowledge graphs 314. The retrieval augmented generation is configured to relevant information from the equipment data provided by the one or more users. This retrieved information is then applied to augment and improve the generation of at least one of the: rules, one or more indicator algorithms, and the one or more knowledge graphs by the AI-based system 102.

In other words, the retrieval augmented generation engine of the response generating subsystem 216 is configured to obtain data associated with the one or more equipments. The retrieval augmented generation engine of the response generating subsystem 216 is further configured to correlate the obtained data associated with the one or more equipments, with at least one of: the one or more pre-defined knowledge graphs, one or more documents, and one or more external sources, using a retrieval augmented generation engine. The retrieval augmented generation engine of the response generating subsystem 216 is further configured to retrieve relevant information from the data associated with the one or more equipments, using the retrieval augmented generation engine. The retrieval augmented generation engine of the response generating subsystem 216 is further configured to apply the retrieved relevant information to the retrieval augmented generation engine, to generate the one or more knowledge graphs 314.

For instance, as shown in FIG. 3H, the user inputs “car” into the user interface as the equipment. The fault-identifying subsystem 208 is configured to generate the one or more potential faults including an “overload,” based on the existing knowledge and the equipment data. Upon detecting the one or more potential faults, the cause-identifying subsystem 210 is configured to identify “overcharging” as the potential cause, considering factors including at least one of: battery health and charging system issues. Subsequently, the indicator analyzing subsystem 212 is configured to analyze and define the one or more relevant sensors including a voltage sensor, to monitor the one or more indicators including “abnormal voltage readings” and “fluctuating voltage levels,” which are signal overcharging or undercharging conditions. By considering the one or more indicators, the prediction generating subsystem 214 is configured to predict the likelihood of the overcharging or undercharging events occurring.

Further, the response generating subsystem 216 is configured to generate the one or more appropriate responses, based on the one or more responses the user may take the action such as initiating a call to the customer care of the respective car company to address the potential issue and ensure timely maintenance or assistance. The root cause analysis engine is configured to demonstrate how the AI-based system 102 dynamically identifies, analyzes, and responds to the one or more potential faults in the real-time, enhancing the overall reliability and performance of the one or more equipments.

The plurality of subsystem 114 further includes the output subsystem 218 that is communicatively connected to the one or more hardware processors 110. The output subsystem 218 is configured to provide at least one of: the one or more potential faults, the one or more potential causes, the one or more indicators, the one or more predictions, and the one or more responses, as the output in the form of the one or more knowledge graphs 314, to the one or more users through the one or more interfaces associated with the one or more communication devices 106 of the one or more users.

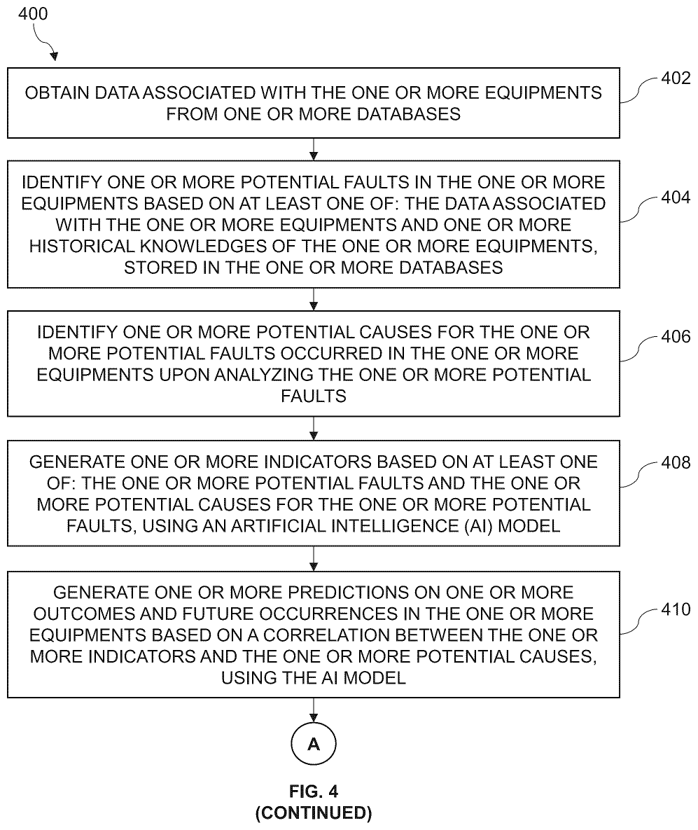

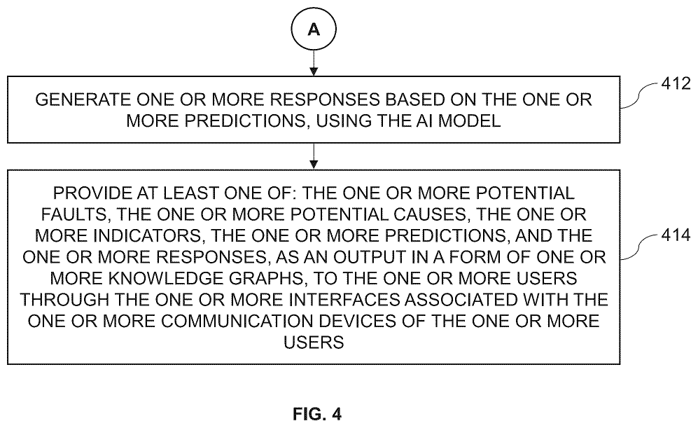

FIG. 4 illustrates a flow chart illustrating an AI-based method 400 for determining the one or more potential issues occurred in the one or more equipments by analyzing the data using the root cause analysis engine, in accordance with an embodiment of the present disclosure.

At step 402, the data associated with the one or more equipments are obtained from the one or more databases 104. In an embodiment, the one or more databases 104 are configured to store the data associated with the one or more equipments, being provided by the one or more users through the one or more interfaces associated with the one or more communication devices 106 of the one or more users.

At step 404, the one or more potential faults in the one or more equipments are identified based on at least one of: the data associated with the one or more equipments and the one or more historical knowledges of the one or more equipments, stored in the one or more databases 104.

At step 406, the one or more potential causes are identified for the one or more potential faults occurred in the one or more equipments upon analyzing the one or more potential faults.

At step 408, the one or more indicators are generated based on at least one of: the one or more potential faults and the one or more potential causes for the one or more potential faults, using the AI model.

At step 410, the one or more predictions on the one or more outcomes and the future occurrences in the one or more equipments are generated based on the correlation between the one or more indicators and the one or more potential causes, using the AI model.

At step 412, the one or more responses are generated based on the one or more predictions, using the AI model. In an embodiment, the one or more responses may include at least one of: the one or more control signals and the one or more insights, provided to mitigate the one or more risks in the one or more equipments, and the one or more recommended actions for the one or more users to make the one or more informed decisions and timely actions, to mitigate the one or more risks.

At step 414, at least one of: the one or more potential faults, the one or more potential causes, the one or more indicators, the one or more predictions, and the one or more responses, as the output in a form of the one or more knowledge graphs 314, to the one or more users through the one or more interfaces associated with the one or more communication devices 106 of the one or more users.

Numerous advantages of the present disclosure may be apparent from the discussion above. In accordance with the present disclosure, the AI-based system 102 is configured to provide the root cause analysis platform to analyze the streaming data is disclosed. The AI-based system 102 is configured to enable the real-time analysis of the streaming data, allowing for prompt detection and the one or more responses to the potential issues and the anomalies. The AI-based system 102 is configured to accurately identify the one or more root causes of the potential issues, helping to address the underlying issues efficiently. The one or more users are empowered to interact with the AI-based system 102, contributing their expertise to the root cause analysis and facilitating collaborative problem-solving.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the AI-based system 102 either directly or through intervening I/O controllers. Network adapters may also be coupled to the AI-based system 102 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/AI-based system 102 in accordance with the embodiments herein. The AI-based system 102 herein comprises at least one processor or central processing unit (CPU). The CPUs are interconnected via the system bus 202 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the AI-based system 102. The AI-based system 102 can read the inventive instructions on the program storage devices and follow these instructions to execute the methodology of the embodiments herein.

The AI-based system 102 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices s which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial-intelligence based (AI-based) method for determining one or more potential issues occurred in one or more equipments by analyzing data using a root cause analysis engine, the AI-based method comprising:
obtaining, one or more hardware processors, the data associated with the one or more equipments from one or more databases, wherein the one or more databases are configured to store the data associated with the one or more equipments, being provided by the one or more users through one or more interfaces associated with one or more communication devices of the one or more users;
identifying, by the one or more hardware processors, one or more potential faults in the one or more equipments based on at least one of: the data associated with the one or more equipments and one or more historical knowledges of the one or more equipments, stored in the one or more databases;
identifying, by the one or more hardware processors, one or more potential causes for the one or more potential faults occurred in the one or more equipments upon analyzing the one or more potential faults;
generating, by the one or more hardware processors, one or more indicators based on at least one of: the one or more potential faults and the one or more potential causes for the one or more potential faults, using an artificial intelligence (AI) model;
generating, by the one or more hardware processors, one or more predictions on one or more outcomes and future occurrences in the one or more equipments based on a correlation between the one or more indicators and the one or more potential causes, using the AI model;
generating, by the one or more hardware processors, one or more responses based on the one or more predictions, using the AI model, wherein the one or more responses comprise at least one of: one or more control signals and one or more insights, provided to mitigate one or more risks in the one or more equipments, and one or more recommended actions for the one or more users to make one or more informed decisions and timely actions, to mitigate the one or more risks; and
providing, by the one or more hardware processors, at least one of: the one or more potential faults, the one or more potential causes, the one or more indicators, the one or more predictions, and the one or more responses, as an output in a form of one or more knowledge graphs, to the one or more users through the one or more interfaces associated with the one or more communication devices of the one or more users.

2. The AI-based method of claim 1, wherein generating the one or more indicators based on at least one of: the one or more potential faults and the one or more potential causes for the one or more potential faults, using the artificial intelligence (AI) model, comprises:
obtaining, by the one or more hardware processors, information associated with at least one of: the one or more potential faults and the one or more potential causes;
analyzing, by the one or more hardware processors, one or more sensors to generate one or more sensor signals based on at least one of: the one or more potential faults and the one or more potential causes, wherein the one or more sensor signals are interpreted by the one or more indicators;
generating, by the one or more hardware processors, one or more values for the one or more indicators by combining the one or more sensor signals; and
classifying, by the one or more hardware processors, the one or more indicators for accurately diagnosing and proactively maintaining the one or more equipments, based on the one or more values generated for the one or more indicators.

3. The AI-based method of claim 1, wherein generating the one or more predictions, using the AI model, comprises:
obtaining, by the one or more hardware processors, the information associated with the one or more indicators;
multiplying, by the one or more hardware processors, the one or more indicators by corresponding one or more weights to provide a value to the one or more predictions;
determining, by the one or more hardware processors, whether the one or more indicators and the corresponding one or more weights, exceed a pre-determined threshold value; and
generating, by the one or more hardware processors, the one or more predictions upon determining that the one or more indicators and the corresponding one or more weights, exceed a pre-determined threshold value.

4. The AI-based method of claim 1, wherein generating the one or more responses based on the one or more predictions, using the AI model, comprises:
obtaining, by the one or more hardware processors, the one or more sensor signals interpreted as the one or more indicators, from the one or more sensors;
obtaining, by the one or more hardware processors, one or more expert knowledges comprising pre-defined data associated with at least one of: one or more pre-defined drool rules, one or more pre-defined indicator algorithms, and one or more pre-defined knowledge graphs, from one or more generative Al models based on one or more inputs associated with the one or more expert knowledges, received from one or more expert knowledge systems of one or more domain experts; and
executing, by the one or more hardware processors, the one or more expert knowledges comprising the pre-defined data associated with at least one of: the one or more pre-defined drool rules, the one or more pre-defined indicator algorithms, and the one or more pre-defined knowledge graphs, within an AI-based system to generate the one or more predictions and the one or more responses with respect to the predictions in the data associated with the one or more equipments.

5. The AI-based method of claim 4, further comprising:
dynamically receiving, by the one or more hardware processors, the pre-defined data associated with the one or more pre-defined drool rules, from a drool inference engine of the one or more expert knowledge systems;
correlating, by the one or more hardware processors, the one or more sensor signals interpreted as the one or more indicators, with the pre-defined data associated with the one or more pre-defined drool rules; and
generating, by the one or more hardware processors, the one or more predictions and the one or more responses with respect to the predictions in the data associated with the one or more equipments, based on the correlation of the one or more sensor signals interpreted as the one or more indicators, with the pre-defined data associated with the one or more pre-defined drool rules.

6. The AI-based method of claim 5, further comprising updating, by the one or more hardware processors, the pre-defined data associated with the one or more pre-defined drool rules, using the drool inference engine, based on one or more changes in at least one of: one or more characteristics of the data associated with the one or more equipments, to one or more analysis requirements, to optimize an adaptability of the AI-based system over time.

7. The AI-based method of claim 4, further comprising:
obtaining, by the one or more hardware processors, data associated with the one or more equipments;
correlating, by the one or more hardware processors, the obtained data associated with the one or more equipments, with at least one of: the one or more pre-defined knowledge graphs, one or more documents, and one or more external sources, using a retrieval augmented generation engine;
retrieving, by the one or more hardware processors, relevant information from the data associated with the one or more equipments, using the retrieval augmented generation engine; and
applying, by the one or more hardware processors, the retrieved relevant information to the retrieval augmented generation engine, to generate the one or more knowledge graphs.

8. An artificial-intelligence based (AI-based) system for determining one or more potential issues occurred in one or more equipments by analyzing data using a root cause analysis engine, the AI-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain the data associated with the one or more equipments from one or more databases, wherein the one or more databases are configured to store the data associated with the one or more equipments, being provided by the one or more users through one or more interfaces associated with one or more communication devices of the one or more users;
a faults identifying subsystem configured to identify one or more potential faults in the one or more equipments based on at least one of: the data associated with the one or more equipments and one or more historical knowledges of the one or more equipments, stored in the one or more databases;
a causes identifying subsystem configured to identify one or more potential causes for the one or more potential faults occurred in the one or more equipments upon analyzing the one or more potential faults;
an indicator generating subsystem configured to generate one or more indicators based on at least one of: the one or more potential faults and the one or more potential causes for the one or more potential faults, using an artificial intelligence (AI) model;
a prediction generation subsystem configured to generate one or more predictions on one or more outcomes and future occurrences in the one or more equipments based on a correlation between the one or more indicators and the one or more potential causes, using the AI model;
a response generating subsystem configured to generate one or more responses based on the one or more predictions, using the AI model, wherein the one or more responses comprise at least one of: one or more control signals and one or more insights, provided to mitigate one or more risks in the one or more equipments, and one or more recommended actions for the one or more users to make one or more informed decisions and timely actions, to mitigate the one or more risks; and
an output subsystem configured to provide at least one of: the one or more potential faults, the one or more potential causes, the one or more indicators, the one or more predictions, and the one or more responses, as an output in a form of one or more knowledge graphs, to the one or more users through the one or more interfaces associated with the one or more communication devices of the one or more users.

9. The AI-based system of claim 8, wherein in generating the one or more indicators based on at least one of: the one or more potential faults and the one or more potential causes for the one or more potential faults, using the artificial intelligence (AI) model, the indication generating subsystem is configured to:
obtain information associated with at least one of: the one or more potential faults and the one or more potential causes;
analyze one or more sensors to generate one or more sensor signals based on at least one of: the one or more potential faults and the one or more potential causes, wherein the one or more sensor signals are interpreted by the one or more indicators;
generate one or more values for the one or more indicators by combining the one or more sensor signals; and
classify the one or more indicators for accurately diagnosing and proactively maintaining the one or more equipments, based on the one or more values generated for the one or more indicators.

10. The AI-based system of claim 8, wherein in generating the one or more predictions, using the AI model, the prediction generating subsystem is configured to:
obtain the information associated with the one or more indicators;
multiply the one or more indicators by corresponding one or more weights to provide a value to the one or more predictions;
determine whether the one or more indicators and the corresponding one or more weights, exceed a pre-determined threshold value; and
generate the one or more predictions upon determining that the one or more indicators and the corresponding one or more weights, exceed a pre-determined threshold value.

11. The AI-based system of claim 8, wherein in generating the one or more responses based on the one or more predictions, using the AI model, the response generating subsystem is configured to:
obtain the one or more sensor signals interpreted as the one or more indicators, from the one or more sensors;
obtain one or more expert knowledges comprising pre-defined data associated with at least one of: one or more pre-defined drool rules, one or more pre-defined indicator algorithms, and one or more pre-defined knowledge graphs, from one or more generative AI models based on one or more inputs associated with the one or more expert knowledges, received from one or more expert knowledge systems of one or more domain experts; and
execute the one or more expert knowledges comprising the pre-defined data associated with at least one of: the one or more pre-defined drool rules, the one or more pre-defined indicator algorithms, and the one or more pre-defined knowledge graphs, within an AI-based system to generate the one or more predictions and the one or more responses with respect to the predictions in the data associated with the one or more equipments.

12. The AI-based method of claim 11, wherein the response generating subsystem is further configured to:
dynamically receive the pre-defined data associated with the one or more pre-defined drool rules, from a drool inference engine of the one or more expert knowledge systems;
correlate the one or more sensor signals interpreted as the one or more indicators, with the pre-defined data associated with the one or more pre-defined drool rules; and
generate the one or more predictions and the one or more responses with respect to the predictions in the data associated with the one or more equipments, based on the correlation of the one or more sensor signals interpreted as the one or more indicators, with the pre-defined data associated with the one or more pre-defined drool rules.

13. The AI-based method of claim 12, wherein the response generating subsystem is further configured to update the pre-defined data associated with the one or more pre-defined drool rules, using the drool inference engine, based on one or more changes in at least one of: one or more characteristics of the data associated with the one or more equipments, to one or more analysis requirements, to optimize an adaptability of the AI-based system over time.

14. The AI-based method of claim 11, wherein the response generating subsystem is further configured to:
obtain data associated with the one or more equipments;
correlate the obtained data associated with the one or more equipments, with at least one of: the one or more pre-defined knowledge graphs, one or more documents, and one or more external sources, using a retrieval augmented generation engine;
retrieve relevant information from the data associated with the one or more equipments, using the retrieval augmented generation engine; and
apply the retrieved relevant information to the retrieval augmented generation engine, to generate the one or more knowledge graphs.

15. A non-transitory computer-readable storage medium having instructions stored therein that when executed by one or more hardware processors, cause the one or more hardware processors to execute operations of:
obtaining data associated with the one or more equipments from one or more databases, wherein the one or more databases are configured to store the data associated with the one or more equipments, being provided by the one or more users through one or more interfaces associated with one or more communication devices of the one or more users;
identifying one or more potential faults in the one or more equipments based on at least one of: the data associated with the one or more equipments and one or more historical knowledges of the one or more equipments, stored in the one or more databases;
identifying one or more potential causes for the one or more potential faults occurred in the one or more equipments upon analyzing the one or more potential faults;
generating one or more indicators based on at least one of: the one or more potential faults and the one or more potential causes for the one or more potential faults, using an artificial intelligence (AI) model;
generating one or more predictions on one or more outcomes and future occurrences in the one or more equipments based on a correlation between the one or more indicators and the one or more potential causes, using the AI model;
generating one or more responses based on the one or more predictions, using the AI model, wherein the one or more responses comprise at least one of:
one or more control signals and one or more insights, provided to mitigate one or more risks in the one or more equipments, and one or more recommended actions for the one or more users to make one or more informed decisions and timely actions, to mitigate the one or more risks; and
providing at least one of: the one or more potential faults, the one or more potential causes, the one or more indicators, the one or more predictions, and the one or more responses, as an output in a form of one or more knowledge graphs, to the one or more users through the one or more interfaces associated with the one or more communication devices of the one or more users.

16. The non-transitory computer-readable storage medium of claim 15, wherein generating the one or more indicators based on at least one of: the one or more potential faults and the one or more potential causes for the one or more potential faults, using the artificial intelligence (AI) model, comprises:
obtaining information associated with at least one of: the one or more potential faults and the one or more potential causes;
analyzing one or more sensors to generate one or more sensor signals based on at least one of: the one or more potential faults and the one or more potential causes, wherein the one or more sensor signals are interpreted by the one or more indicators;
generating one or more values for the one or more indicators by combining the one or more sensor signals; and
classifying the one or more indicators for accurately diagnosing and proactively maintaining the one or more equipments, based on the one or more values generated for the one or more indicators.

17. The non-transitory computer-readable storage medium of claim 15, wherein generating the one or more predictions, using the AI model, comprises:
obtaining the information associated with the one or more indicators;
multiplying the one or more indicators by corresponding one or more weights to provide a value to the one or more predictions;
determining whether the one or more indicators and the corresponding one or more weights, exceed a pre-determined threshold value; and
generating the one or more predictions upon determining that the one or more indicators and the corresponding one or more weights, exceed a pre-determined threshold value.

18. The non-transitory computer-readable storage medium of claim 15, wherein generating the one or more responses based on the one or more predictions, using the AI model, comprises:
obtaining the one or more sensor signals interpreted as the one or more indicators, from the one or more sensors;
obtaining one or more expert knowledges comprising pre-defined data associated with at least one of: one or more pre-defined drool rules, one or more pre-defined indicator algorithms, and one or more pre-defined knowledge graphs, from one or more generative AI models based on one or more inputs associated with the one or more expert knowledges, received from one or more expert knowledge systems of one or more domain experts; and
executing the one or more expert knowledges comprising the pre-defined data associated with at least one of: the one or more pre-defined drool rules, the one or more pre-defined indicator algorithms, and the one or more pre-defined knowledge graphs, within an AI-based system to generate the one or more predictions and the one or more responses with respect to the predictions in the data associated with the one or more equipments.

19. The non-transitory computer-readable storage medium of claim 17, further comprising:
dynamically receiving the pre-defined data associated with the one or more pre-defined drool rules, from a drool inference engine of the one or more expert knowledge systems;
correlating the one or more sensor signals interpreted as the one or more indicators, with the pre-defined data associated with the one or more pre-defined drool rules; and
generating the one or more predictions and the one or more responses with respect to the predictions in the data associated with the one or more equipments, based on the correlation of the one or more sensor signals interpreted as the one or more indicators, with the pre-defined data associated with the one or more pre-defined drool rules.

20. The non-transitory computer-readable storage medium of claim 17, further comprising:
obtaining data associated with the one or more equipments;
correlating the obtained data associated with the one or more equipments, with at least one of: the one or more pre-defined knowledge graphs, one or more documents, and one or more external sources, using a retrieval augmented generation engine;
retrieving relevant information from the data associated with the one or more equipments, using the retrieval augmented generation engine; and
applying the retrieved relevant information to the retrieval augmented generation engine, to generate the one or more knowledge graphs.
